(19) United States
(12) Patent Application Publication
(10) Pub. No.: US 2026/0025514 A1
(43) Pub. Date: Jan. 22, 2026

(54) CROSS-RETARGETING FOR INTER PREDICTION

(71) Applicant: GUANGDONG OPPO MOBILE TELECOMMUNICATIONS CORP., LTD., Dongguan (CN)

(72) Inventors: Marek DOMANSKI, Poznan (PL); Slawomir ROZEK, Poznan (PL); Tomasz GRAJEK, Poznan (PL); Jakub STANKOWSKI, Poznan (PL); Olgierd STANKIEWICZ, Poznan (PL); Slawomir MACKOWIAK, Poznan (PL); Maciej WAWRZYNIAK, Poznan (PL); Mateusz LORKIEWICZ, Poznan (PL)

(21) Appl. No.: 19/269,581

(22) Filed: Jul. 15, 2025

(30) Foreign Application Priority Data
Jul. 16, 2024 (EP) 24461596.9

(51) Int. Cl. H04N 19/159; H04N 19/105; H04N 19/172

(52) U.S. Cl. CPC H04N 19/159; H04N 19/105; H04N 19/172

(57) ABSTRACT

A method of processing video data, performed by a decoder, is provided. The method includes that: a bitstream including a first picture retargeted according to a first retargeting scheme and a second picture retargeted according to a second retargeting scheme is received; the first picture is decoded from the bitstream to generate a first decoded picture; the first decoded picture is adapted to the second retargeting scheme to generate a reference picture; the second picture is decoded from the bitstream to generate a second decoded picture, wherein the operation of decoding the second picture includes inter prediction using the reference picture; and an output sequence including the first and second decoded pictures is generated.

### CROSS-REFERENCE TO RELATED APPLICATION

This application claims priority to European Patent Application No. 24461596.9, filed on Jul. 16, 2024, the entire content of which is incorporated herein by reference in its entirety.

### BACKGROUND

Inter prediction (sometimes referred to as “inter frame prediction”) is a process by which a given frame (or picture) in a video stream is decoded by reference to one or more neighbouring frames. This technique can enable higher compression rates since neighbouring frames are commonly similar in many aspects. Inter prediction is widely used in many current encoding schemes, including H.265/HEVC and H.266/VVC video coding systems.

Retargeting is a technique proposed to enhance the fidelity of coding systems for regions of interest (Rols). In general, retargeting may include adaptively scaling the original frames to increase the relative weight of one or more Rols (and conversely decrease the relative weight of areas of the frame not considered important). In this way, a retargeted encoded bitstream may include a higher number of bits carrying information relating to the Rols compared to other aspects of the picture, thereby improving fidelity for the ROIs in particular. At the decoder end, an inverse process may be applied to return the frame to the original relative scaling between Rols and the rest of the frame.

Retargeting has been proposed within the Video Coding for Machines (VCM) coding system, for example. It is desirable to ensure that retargeting and inter prediction may operate effectively in conjunction.

### SUMMARY

The present disclosure relates to the field of computer vision, in particular to the topic of video processing and video coding, more particularly to a method, a decoder, an encoder, and a computer-readable medium for performing inter prediction.

Embodiments of the present disclosure provide a method, a decoder, an encoder, and a computer-readable medium for video coding using inter prediction and retargeting that overcome problems associated with conventional arrangements.

According to a first aspect, there is provided a method of processing video data, performed by a decoder, the method comprising: receiving a bitstream comprising a first encoded picture retargeted according to a first retargeting scheme and a second encoded picture retargeted according to a second retargeting scheme; decoding the first encoded picture from the bitstream to generate a first decoded picture; adapting the first decoded picture to the second retargeting scheme to generate a reference picture; decoding the second encoded picture from the bitstream to generate a second decoded picture, wherein decoding the second encoded picture comprises inter prediction using the reference picture; and generating an output sequence comprising the first and second decoded pictures.

According to a second aspect, there is provided a decoder, comprising: one or more processors; and a computer-readable medium comprising computer executable instructions stored thereon which when executed by the one or more processors cause the one or more processors to perform the following operations: receiving a bitstream comprising a first encoded picture retargeted according to a first retargeting scheme and a second encoded picture retargeted according to a second retargeting scheme; decoding the first encoded picture from the bitstream to generate a first decoded picture; adapting the first decoded picture to the second retargeting scheme to generate a reference picture; decoding the second encoded picture from the bitstream to generate a second decoded picture, wherein decoding the second encoded picture comprises inter prediction using the reference picture; and generating an output sequence comprising the first and second decoded pictures.

According to a third aspect, there is provided a method of processing video data, performed by an encoder, the method comprising: obtaining an input sequence comprising a first picture and a second picture; applying a first retargeting scheme to the first picture to generate a first retargeted picture and a second retargeting scheme to the second picture to generate a second retargeted picture; encoding the first retargeted picture to generate a first encoded picture; decoding the first encoded picture to generate a first decoded picture; adapting the first decoded picture to the second retargeting scheme to generate a reference picture; encoding the second retargeted picture to generate a second encoded picture, wherein encoding the second retargeted picture comprises inter prediction using the reference picture; and generating a bitstream comprising the first and second encoded pictures.

These and other aspects of the present disclosure may become more readily apparent from the following description of the embodiments.

### BRIEF DESCRIPTION OF THE DRAWINGS

Embodiments will now be described, by way of example only, with reference to the accompanying drawings, in which:

FIG. 1 schematically shows the components of a decoder for performing inter prediction;

FIG. 2 schematically shows encoder and decoder components for performing retargeting;

FIG. 3 shows a flowchart of the operations of a decoder according to an embodiment of the present disclosure;

FIG. 4 shows a flowchart of the operations of an encoder according to an embodiment of the present disclosure;

FIG. 5 schematically shows the components of a decoder for the operations of FIG. 3;

FIG. 6 schematically shows the components of an encoder for the operations of FIG. 4;

FIG. 7 shows the effect of retargeting steps upon a first picture and a second picture;

FIG. 8 shows a schematic illustration of a decoder according to various embodiments; and

FIG. 9 shows a schematic illustration of an encoder according to various embodiments.

### DETAILED DESCRIPTION

Technical solutions in the embodiments will be described clearly and completely below with reference to the accompanying drawings.

These technical solutions may be applied to Video Coding for Machines (VCM), H.265/HEVC, or H.266/VVC video coding systems. However, it is to be understood that these technical solutions may be applied in any other video coding system that involves the interpolation of a picture based on other temporally spaced pictures. For example, these technical solutions may be applied in any video coding system that uses temporal resampling.

A “video” in the embodiments refers to a plurality of temporally spaced pictures. A picture may also be referred to as an “image”. Temporally spaced pictures may also be referred to as “frames”.

An “encoder” is a device capable of encoding data into a bitstream, while a “decoder” is a device capable of decoding the bitstream in order to obtain the encoded data, or an approximation of the encoded data. A “bitstream” comprises a sequence of bits.

In the embodiments, or “original video” or “original video data” is used to refer to the data prior to encoding at the encoder.

In this document, interpolation involves the creation or generation of a frame (or picture) between a plurality of temporally-spaced existing frames (or pictures). For example, data for a first region of a first frame/picture is used in generating data for a second region of a second frame/picture. The first and second region may or may not be spatially separated from one another. This may sometimes use multiple reference regions from different frames or pictures at once, i.e. for a single interpolation operation. This is often called “hierarchical interpolation”.

A “block” in the embodiments may refer to a portion of a picture. For example, a picture may be portioned into two or more blocks. However, this is only an example. If a picture is not partitioned, then a “block” can refer to the entire picture.

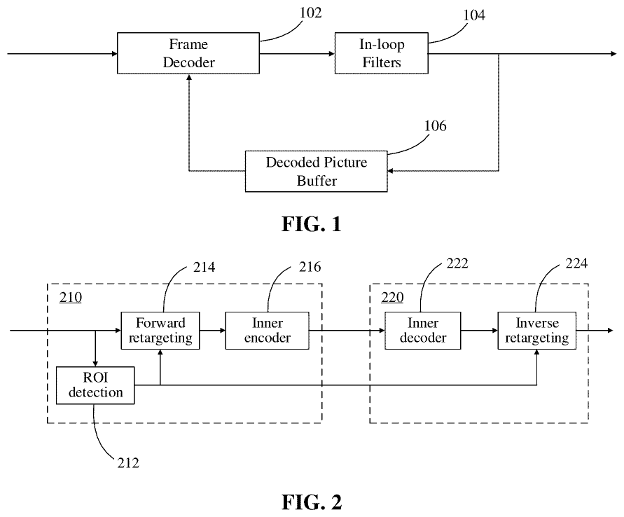

The principles of inter prediction and retargeting may be understood with respect of FIGS. 1 and 2 respectively.

FIG. 1 illustrates an operation of inter prediction at a decoder. The compressed bitstream is first received at a frame decoder 102, where each frame is decoded according to the coding system being operated.

A first frame, such as an I frame, may have no reference to any previous frames and thus be directly decoded from the bitstream. This first decoded frame is passed to in-loop filters 104. The in-loop filters 104 operate to remove artifacts associated with the encoding/decoding process. For example, quantization and picture partitioning in the encoder-decoder process may cause coding artifacts and the in-loop filters 104 may act to reduce the effect of these.

Once the in-loop filters 104 have acted upon the first frame, it's processing may be complete and it can thus be considered as a final reconstructed picture, ready for presentation and so on. However, as well as being passed to the output of the decoder, the process may retain the first frame in a decoded picture buffer 106 for use in inter prediction.

Accordingly, when a second frame is received in the compressed bitstream, the frame decoder 102 may use the copy of the first frame stored in the decoded picture buffer 106 for inter prediction. In this way, the second frame may be encoded in the bitstream with reference to elements of the first frame, and the frame decoder 102 may utilise these references together with the copy of the first frame stored in the decoded picture buffer to reconstruct the second picture frame.

Once the second frame is decoded by the frame decoder 102 it is passed to the in-loop filters 104 for processing in the same manner as the first frame. It may then be provided to the output of the decoder. Moreover, the second frame may then be stored in the decoded picture buffer 106 for use in decoding a subsequent frame.

FIG. 2 schematically illustrates an implementation of retargeting. In a retargeting process, the size and/or proportions of a picture and/or regions of a picture may be altered. In general, this is done in order to allocate relatively greater area (and thus more bits) to the Regions of Interest (Rol) and to allocate relatively smaller area (and thus fewer bits) to regions of lesser importance. Consequently, content within Regions of Interest (ROIs) may be encoded with high fidelity, while the remaining regions in a frame may be downsized or even removed. As a result, frames with distorted proportions and/or reduced resolution are created. In the decoder, the original dimensions of Rols are restored through inverse processing using additional information transmitted within the bitstream.

FIG. 2 illustrates encoder 210 operations and decoder 220 operations. At the encoder, a forward retargeter 214 is provided to perform forward retargeting: this is a step performed as preprocessing before encoding of the video sequence, which transforms the original size and/or proportions to the transmitted size and/or proportions of the content. Correspondingly, an inverse retargeter 224 is provided at the decoder 220 to perform inverse retargeting: a step performed as postprocessing after decoding of the video sequence, which transforms the transmitted size and/or proportions back to the original size and/or proportions of the content. In addition, there is also provide an ROI detector 212 at the encoder.

When a video stream comprising a plurality of pictures in a sequence arrives at a detector, each picture is processed. Within the encoder 210, the ROI detector 212 identifies ROIs in the picture. The ROI detector 212 forwards ROI metadata to the forward retargeter 214 in order that it can perform forward retargeting. The forward retargeter 214 then acts on the picture to make the adjustments to picture size and/or proportion considered appropriate given the ROIs in the picture. The adjusted picture is then encoded by inner encoder 216 using a selected encoding scheme. This generates a compressed picture and a sequence of compressed pictures together forms a compressed video bitstream.

The compressed video bitstream and the ROI metadata are transmitted to the decoder side. An inner decoder 222 operates to decode the retargeted pictures, which are then acted on by the inverse retargeter 224 to recover a reconstructed picture of the same size and/or proportions as the original picture.

Incorporating inter prediction as illustrated in FIG. 1 within the retargeting framework of FIG. 2 presents a challenge. Neither the output of the inner decoder 222 (which has retargeted size and/or proportions based on the Rols identified for that picture) nor the output of the inverse retargeter 224 (which has size/proportions in line with the original picture) are optimal for use in inter prediction on a subsequent picture. This problem becomes more acute the more variable the forward retargeting process becomes; however, static forward retargeting within a sequence of pictures does not provide the improved fidelity/compression benefits that may be available for a retargeting scheme tailored to each picture.

Since inter prediction may involve the current encoded picture being predicted from a previously encoded one, it is generally challenging to apply to video sequences containing varying proportions of objects and pictures of different resolutions. Retargeting provides a context in which such variations between pictures may be desirable, as objects (Rols) may be scaled in a different way in each frame. For example, the same Rol in consecutive frames may exhibit different sizes.

While some challenges associated with video sequences having pictures of different resolutions may be addressed through, for example, adding some padding to reach original resolution or greying out missing pixels, these techniques do not address fully the deleterious effects on inter prediction that may arise. For example, the proportions of content may still differ between pictures, leading to challenges and/or inefficiency in implementing inter prediction. Similarly, while the tool called Reference Picture Resampling (RPN) implemented in the VVC video codec, which involves scaling (resampling) a picture from the reference list to have the same resolution as the encoded one, also does not address proportions.

The present disclosure provides a technique of cross-retargeting to address these challenges. In particular, a first encoded picture in a sequence may be retargeted to comply with a retargeting scheme associated with a second encoded picture—this is termed as cross-retargeting-allowing the cross-retargeted picture to be used for inter prediction processes related to the second encoded picture.

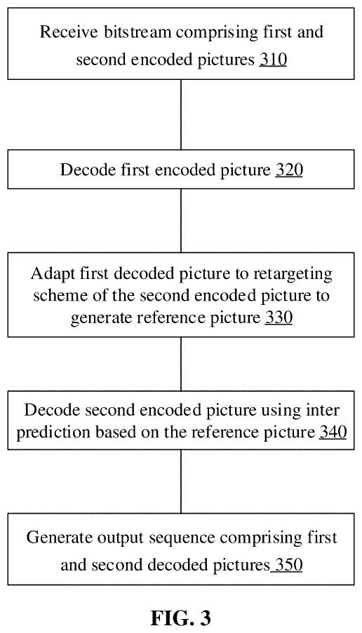

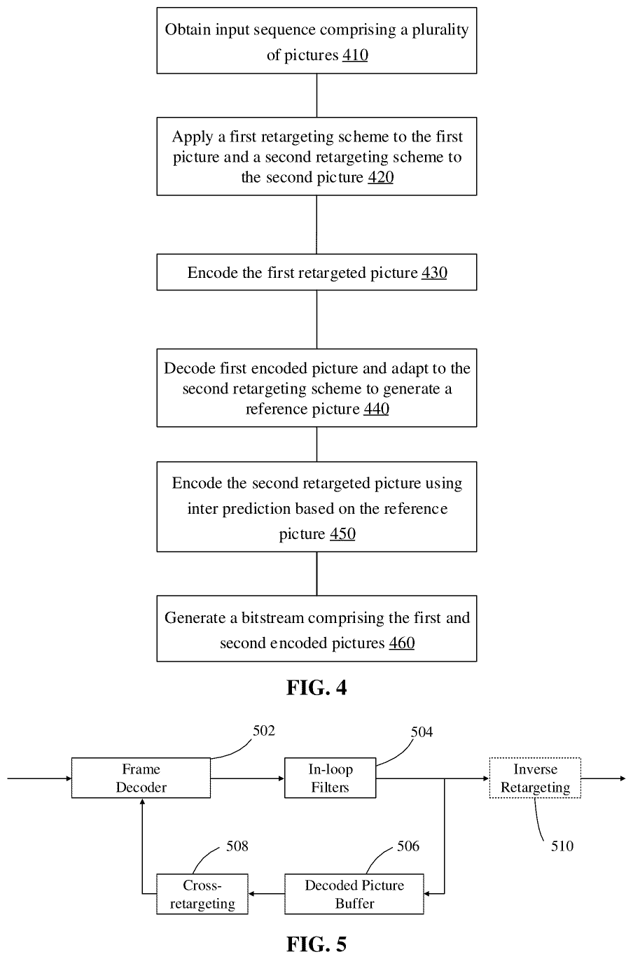

An example method operated at a decoder is illustrated in FIG. 3, and can be further understood with reference to the schematic diagram of the decoder operations provided in FIG. 5.

In this method a bitstream is received by the decoder at step 310. The bitstream comprises a sequence of encoded pictures, including pictures referred to in the description of this method as a first encoded picture and a second encoded picture. The first encoded picture may have been encoded without reference to any other picture (for example, the first encoded picture may be an I frame) while the second encoded picture is encoded using inter prediction based on the first encoded picture.

Moreover, the encoded pictures encoded in the bitstream have been retargeted. Since the contents of each picture may differ, there may be a first retargeting scheme associated with the first encoded picture and a second, different, retargeting scheme associated with the second encoded picture. The decoder may receive metadata describing the first and second retargeting schemes in the bitstream or through another communications channel.

Once the bitstream is received, the Frame Decoder 502 may decode the first encoded picture at step 320. Since the first encoded picture was not encoded with reference to another picture, this decoding may proceed without reference to the second encoded picture. In-loop filters 504 may then be applied to the decoded picture as desired.

The decoded first encoded picture (or “first decoded picture”) may then be passed to a decoded picture buffer 506. A cross-retargeter 508 can then act upon pictures in the buffer 506 to adapt them for use in inter prediction processes for other pictures. In particular, the first decoded picture may be adapted to the retargeting scheme (this is referred to as “cross-retargeting”) of the second encoded picture at step 330. By storing the first decoded picture in the buffer 506 prior to cross-retargeting, this picture can also be used later for decoding pictures subsequent to the second picture in the bitstream. For example, where a third encoded picture is included in the bitstream received at step 310, the first decoded picture in the buffer 506 be adapted to a third retargeting scheme associated with the third encoded picture in order to generate a further reference picture for use in decoding the third encoded picture. The further reference picture may alternatively be generated by adapting the second decoded picture to the third retargeting scheme. In general, a particular decoded picture in the buffer 506 may be adapted to any selected number of retargeting schemes for use in decoding other encoded pictures in the bitstream associated with those retargeting schemes.

The process of adapting the retargeting scheme of the first decoded picture can be understood as follows: we may consider the second encoded picture which is to be decoded as img_A and refer to the first picture in the buffer 506 as ref_1. It will be understood that there may be other pictures in the buffer that can also be used, denoted as ref_2, ref_3 etc. Potential options for adapting the retargeting of the first picture (ref_1) to the second retargeting scheme (i.e. that of img_A/the second picture) are presented below.

### Option I

1. Based on retargeting data for the picture ref_1 (the first encoded picture) and retargeting data for the currently to-be-decoded picture img_A (the second encoded picture) estimate resampling of Rols from ref_1 to match the size and/or proportions of Rols in the img_A resulting in scaledref_1_A.
2. Use scaledref_1_A as a reference picture in the INTER prediction for img_A.
3. When another reference picture is used in INTER prediction, perform the operations from 1 to 2 to this reference picture from the list in place of performing these operations for img ref_1 (e.g. for a new reference picture ref_2 used in decoding a new to-be-decoded picture img_B, create scaledref_2_B for use in INTER prediction for img_B).

### Option II

1. Perform inverse retargeting of the picture ref_1 according to its own retargeting data resulting in retref_1 picture.
2. Perform retargeting of the picture retref_1 according to retargeting data from the currently to-be-decoded picture img_A resulting in the scaledref_1_A.
3. Use scaledref_1_A as a reference picture in the INTER prediction for img_A.
4. When another reference picture is used in the INTER prediction, perform the operations from 1 to 3 to this reference picture from the list (for example, for a new reference picture ref_2 used in decoding a new to-be-decoded picture img_B, create scaledref_2_B for use in INTER prediction for img_B).

As such, after adapting the first decoded picture in line with the second retargeting scheme (associated with the second picture) at the cross-retargeter 508, the frame decoder 502 may use the output reference picture for inter prediction when decoding the second picture at step 340.

An output sequence comprising the first and second decoded pictures may then be generated and output at step 350. Inverse retargeter 510 may reverse the retargeting for each picture to return to its original proportions and/or dimensions. That is, an inverse retargeting process according to the first retargeting scheme may be applied to the first decoded picture and an inverse retargeting process according to the second retargeting scheme may be applied to the second decoded picture.

It will be recognised that while first and second pictures are discussed in detail above, there may be a greater number of pictures in the bitstream received at step 310. For example, a third picture may also be provided associated with a third retargeting scheme. As such, once decoded at step 340, the second decoded picture may also be passed to the buffer 506 for use in decoding later pictures in the bitstream.

Earlier pictures in the buffer 506 may be adapted in line with the process of step 330 to correspond to the retargeting scheme of whichever picture is later being decoded in line with step 340. As such, inter prediction in decoding a given picture may utilise one or more other pictures in the bitstream which have been adapted to the retargeting scheme of the given picture. Inter prediction may thus be performed utilising pictures adapted to be consistent with the retargeting scheme of the picture currently being decoded. As such, the benefits of inter prediction may be consistently achieved without impacting on the utility of the retargeting process itself.

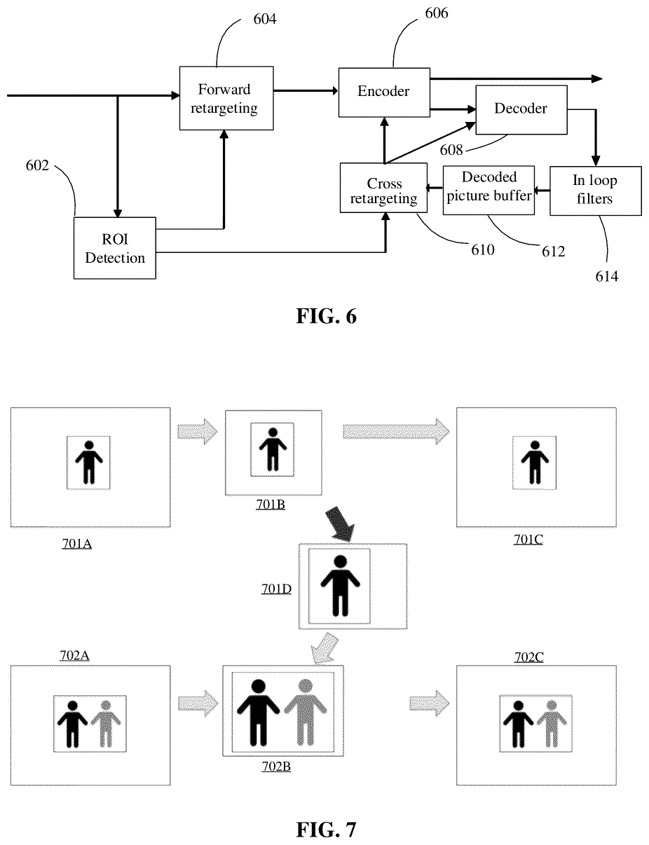

A corresponding encoding process can be understood with reference to FIGS. 4 and 6.

At step 410, a sequence comprising a plurality of pictures is obtained. For the following description, focus is given to a first picture and a second picture of the plurality of pictures, but as above, the skilled person will recognise that the sequence may include additional pictures as desirable.

An Rol detector 602 may identify Rols in the pictures in the sequence and may also define a retargeting scheme for each picture based on the identified Rols. For example, the first picture may be associated with a first retargeting scheme, and a second picture may be associated with a second retargeting scheme, and so on. The Rol detector 602 may comprises one or more machine learning models trained to receive a picture as an input and output an indication of one or more Rols. The machine learning models may be neural network models. The input picture to the machine learning models may comprise pixel data, and the output of the machine learning model may identify locations or regions within the input pixel data. In particular, the machine models may be trained to identify one or more objects within the input pictures and provide a Rol output associated with the location of the one or more objects.

At step 420, the first and second pictures (and any others within the sequence) may be retargeted according to their associated retargeting schemes. Once retargeted, pictures may be passed to encoder 606. During encoding inter prediction may be applied based on one or more reference pictures.

The first picture may be encoded at step 430 by encoder 606 without reference to any other pictures. For example, the first picture may be an I-frame. However, it may be desirable to use inter prediction for one or more subsequent pictures in the sequence (such as the second picture).

To assist with this, once encoded, as well as being forwarded for transmission, pictures may be passed to a decoder 608 for decoding prior to being adapted to the retargeting scheme of a later picture (at step 440). The decoder 608 operates in the same manner as decoder 502 (including potentially applying a reference picture for inter prediction based on earlier cross-retargeted pictures), and may pass decoded pictures to in-loop filters 614 which operate in the same manner as in-loop filters 504. Decoded pictures may then be stored in decoded picture buffer 612. Pictures in the buffer (such as the first picture) can be adapted to comply with the retargeting scheme of the picture which is to be encoded by encoder 606 (and/or decoded by decoder 608). For example, cross-retargeter 610 may adapt the first retargeted picture to comply with the second retargeting scheme at step 440 to generate a reference picture. The second retargeted picture may then be encoded by encoder 606 using the reference picture for inter prediction at step 450 and also subsequently decoded at decoder 608 using this scheme. By using pictures which have been encoded and subsequently decoded during inter prediction at the encoder, both encoded and decoder use the same reference picture, avoiding drift.

Moreover, where a third picture is included in the input sequence, the first decoded picture may be adapted to a third retargeting scheme applied to the third picture in order to generate a further reference picture for use in decoding the third encoded picture. The further reference picture may alternatively be generated by decoding the second encoded picture to create a second decoded picture, and adapting the second decoded picture to the third retargeting scheme. In general, a particular decoded picture in the buffer 612 may be adapted to any selected number of retargeting schemes for use in decoding other encoded pictures in the bitstream associated with those retargeting schemes.

Encoded pictures (such as first and second encoded pictures) can then form part of a bitstream generated at step 460. The bitstream may then be transmitted to a decoder at a receiver side which operates in line with the process described above with relation to FIG. 3.

By incorporating a retargeting step prior to inter prediction for a reference picture which is based on the retargeting scheme for the picture to be encoded or decoded, variations in the retargeting scheme applied to different pictures can be adopted without impacting on the fidelity of inter prediction. In particular, a first decoded picture associated with a first retargeting scheme can be adapted to comply with a second retargeting scheme associated with a second (encoded) picture and consequently inter prediction can be used in the retargeted domain for the second (encoded) picture. At the same time, the ability to recover both the first and second pictures using their respective retargeting schemes is not impacted. As such, the benefits of both retargeting and inter prediction, such as improved fidelity for a given bitstream size, can be achieved without conflict.

The processes of forward retargeting, cross-retargeting and reverse retargeting can be understood with reference to FIG. 7. In this FIG. the first picture 701 is shown as present in the original input sequence in picture 701A, after the application of forward retargeting in picture 701B, and after inverse retargeting in picture 701C. Similarly, the second picture 702 is shown as present in the original input sequence in picture 702A, after the application of forward retargeting in picture 702B, and after inverse retargeting in picture 702C.

It can be noted that pictures 701C and 702C correspond in size and proportion to pictures 701A and 702A. That is, the inverse retargeting step to obtain pictures 701C, 702C reverses the process applied to the original pictures 701A, 702A to obtain retargeted pictures 701B, 702B.

However, since the retargeting schemes applied to first picture 701 and second picture 702 differ, the retargeted pictures 701B and 702B differ in size and proportion. Given that the encoding/decoding process operates on retargeted pictures, this creates a difficulty for inter prediction, absent the cross-retargeting process described above. As shown in FIG. 7, a cross retargeted version of first picture 701 is generated from retargeted picture 701B as cross-retargeted picture 701D. Cross-retargeted picture 701D complies with the retargeting scheme used to generate picture 702B, and can thus be used for inter encoding and/or inter decoding this picture.

In order to perform retargeting steps above, various approaches may be adopted. These can be applied to forward retargeting, cross-retargeting and inverse retargeting as appropriate.

For example, energy-base seam-carving retargeting methods are known in the art. In these processes, an energy picture may be transmitted and available to both the encoder and decoder sides. Such functions may establish a number of seams (paths of least importance) in a picture and automatically remove seams to reduce picture size or insert seams to extend it. The “energy” of the seam may represent its importance to the picture, such that identifying an energy value can indicate whether a seam should be removed or further focus added. It is possible also to directly specify regions of the picture which are or are not of interest in order to handle these appropriately. Thus, in the methods above the Rol detectors can be replaced or supplemented with detectors for automatically assessing the energy of seams in the picture.

Other approaches to retargeting include rectangle-scaling-based retargeting. In this approach, the change of scale and/or proportions of the content is defined through means of e.g. a rectangular source grid or a rectangular target grid. Retargeting may then be performed by scaling of particular, corresponding fields of the grid. In some examples, the grids (both source and target) may be directly transmitted to the relevant elements of the encoder and/or decoder which perform retargeting operations. In others, this grids may be calculated based on other data (such as positions of Rols or scaling factors) transmitted as appropriate. International patent application WO 2024/077797, incorporated herein by reference in its entirety, provides an example implementation of such a technique.

In addition, or alternatively, to using rectangular (or square) regions, techniques can adopt other shapes such as circles, triangles, or polygons, without departing from the scope of the present disclosure. Rectangle or square shaped regions may simplify the picture retargeting process and therefore reduces the computation complexity. The rescaling factor associated with an ROI of any shape can be a downscaling factor or an upscaling factor. A downscaling factor describes the maximum level a region can be downsized, while an upscaling factor describes the maximum level a region can be stretched.

The encoder and decoders described above may operate according to any video coding standard, such as Advanced Video Coding (AVC), High Efficiency Video Coding (HEVC), Versatile Video Coding (VVC), AOMedia Video 1 (AV1), Joint Photographic Experts Group (JPEG), Moving Picture Experts Group (MPEG), etc. Alternatively, encoders/decoders may be customized devices that do not comply with the existing standards. Although not shown, in some embodiments, encoder and decoder may each be integrated with an audio encoder and decoder, and may include appropriate MUX-DEMUX units, or other hardware and software, to handle encoding of both audio and video in a common data stream or separate data streams.

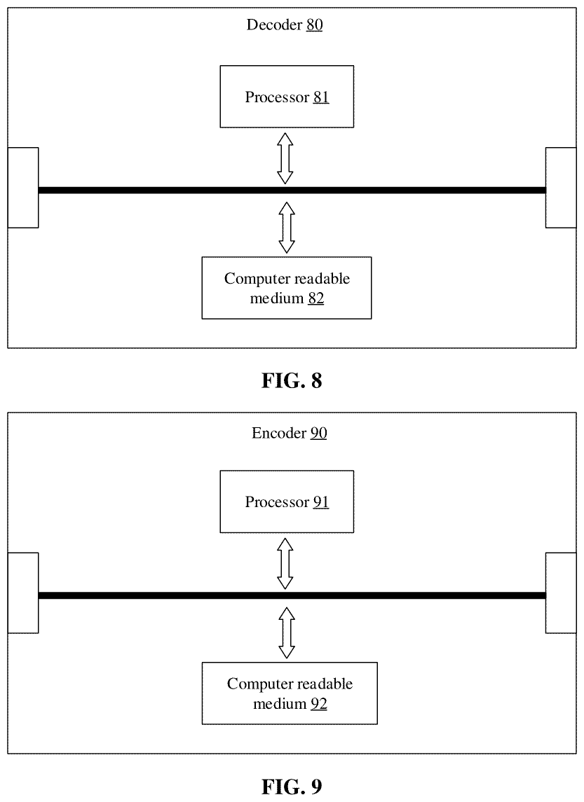

FIG. 8 shows a schematic illustration of a decoder 80 according to an embodiment. Specifically, FIG. 8 shows a schematic illustration of a decoder 80 configured to perform any of the decoder methods discussed herein. Such detailed descriptions thereof are omitted here for brevity.

As shown in FIG. 8, the decoder 80 comprises a processor 81 and a computer readable medium 82. The processor 81 and the computer readable medium 82 may be connected via a bus system. The computer readable medium is configured to store programs, instructions or codes. The processor 81 is configured to execute the programs, the instructions or the codes in the computer readable medium 82 so as to complete the operations in the decoder method embodiments herein.

Hence, in embodiments, the computer readable medium 82 is configured to store a computer program capable of being run in the processor 81, and the processor 81 is configured to run the computer program to perform steps in any of the decoder methods discussed herein.

FIG. 9 shows a schematic illustration of an encoder 90 according to an embodiment. Specifically, FIG. 9 shows a schematic illustration of an encoder 90 configured to perform any of the encoder methods discussed herein. Such detailed descriptions thereof are omitted here for brevity.

As shown in FIG. 9, the encoder 90 comprises a processor 91 and a computer readable medium 92. The processor 91 and the computer readable medium 92 may be connected via a bus system. The computer readable medium is configured to store programs, instructions or codes. The processor 91 is configured to execute the programs, the instructions or the codes in the computer readable medium 92 so as to complete the operations in the encoder method embodiments herein.

Hence, in embodiments, the computer readable medium 92 is configured to store a computer program capable of being run in the processor 91, and the processor 91 is configured to run the computer program to perform steps in any of the encoder methods discussed herein.

This is implemented as part of pre-processing in the encoder and post-processing in the decoder.

Embodiments of the invention can also provide a computer-readable medium having computer-executable instructions to cause one or more processors of a computing device to carry out the method of any of the embodiments of this disclosure.

Examples of computer-readable media include both volatile and non-volatile media, removable and non-removable media, and include, but are not limited to: solid state memories; removable disks; hard disk drives; magnetic media; and optical disks. In general, the computer-readable media include any type of medium suitable for storing, encoding, or carrying a series of instructions executable by one or more computers to perform any one or more of the processes and features described herein.

It will be appreciated that the functionality of each of the components discussed can be combined in a number of ways other than those discussed in the foregoing description. For example, in some embodiments, the functionality of more than one of the discussed devices can be incorporated into a single device. In other embodiments, the functionality of at least one of the devices discussed can be split into a plurality of separate (or distributed) devices.

Conditional language such as “may”, is generally used to indicate that features/steps are used in a particular embodiment, but that alternative embodiments may include alternative features, or omit such features altogether.

Furthermore, the method steps are not limited to the particular sequences described, and it will be appreciated that these can be combined in any other appropriate sequences. In some embodiments, this may result in some method steps being performed in parallel. In addition, in some embodiments, particular method steps may also be omitted altogether.

While certain embodiments have been discussed, it will be appreciated that these are used to exemplify the overall teaching of the present invention, and that various modifications can be made without departing from the scope of the invention. The scope of the invention should is to be construed in accordance with the appended claims and any equivalents thereof.

Many further variations and modifications will suggest themselves to those versed in the art upon making reference to the foregoing illustrative embodiments, which are given by way of example only, and which are not intended to limit the scope of the invention, that being determined by the appended claims.

What is claimed is:

1. A method of processing video data, performed by a decoder, the method comprising:
receiving a bitstream comprising a first encoded picture retargeted according to a first retargeting scheme and a second encoded picture retargeted according to a second retargeting scheme;
decoding the first encoded picture from the bitstream to generate a first decoded picture;
adapting the first decoded picture to the second retargeting scheme to generate a reference picture;
decoding the second encoded picture from the bitstream to generate a second decoded picture, wherein decoding the second encoded picture comprises inter prediction using the reference picture; and
generating an output sequence comprising the first and second decoded pictures.

2. The method according to claim 1, further comprising applying an inverse retargeting process to the first and second decoded pictures according to the first and second retargeting schemes respectively.

3. The method according to claim 1, wherein the bitstream further comprises metadata defining the first and second retargeting schemes.

4. The method according to claim 1, further comprising applying one or more in-loop filters prior to adapting the first decoded picture to the second retargeting scheme.

5. The method according to claim 1, further comprising storing the first decoded picture in a decoded picture buffer;
wherein adapting the first decoded picture to the second retargeting scheme to generate a reference picture is performed after storing the first decoded picture in the decoded picture buffer.

6. The method of claim 1, wherein the bitstream further comprises a third encoded picture retargeted according to a third retargeting scheme, and the method further comprises:
decoding the third encoded picture from the bitstream to generate a third decoded picture, wherein decoding the third encoded picture comprises inter prediction using a further reference picture.

7. The method of claim 6, further comprising:
adapting the first decoded picture to the third retargeting scheme to generate the further reference picture.

8. The method according to claim 1, wherein adapting the first decoded picture to the second retargeting scheme comprises region-scaling, wherein region-scaling comprises rectangular region-scaling.

9. The method according to claim 8, wherein region-scaling comprises interpolating regions between the first and second retargeting schemes.

10. The method according to claim 1, wherein adapting the first decoded picture to the second retargeting scheme utilises a source grid and a target grid such that adapting is performed by scaling corresponding fields of the source grid and the target grid.

11. The method according to claim 1, wherein adapting the first decoded picture to the second retargeting scheme comprises:
inverse retargeting of the first decoded picture according to the first retargeting scheme; and, subsequently,
forward retargeting of the first decoded picture according to the second retargeting scheme.

12. A decoder, comprising:
one or more processors; and
a computer-readable medium comprising computer executable instructions stored thereon which when executed by the one or more processors cause the one or more processors to perform the following operations:
receiving a bitstream comprising a first encoded picture retargeted according to a first retargeting scheme and a second encoded picture retargeted according to a second retargeting scheme;
decoding the first encoded picture from the bitstream to generate a first decoded picture;
adapting the first decoded picture to the second retargeting scheme to generate a reference picture;
decoding the second encoded picture from the bitstream to generate a second decoded picture, wherein decoding the second encoded picture comprises inter prediction using the reference picture; and
generating an output sequence comprising the first and second decoded pictures.

13. A method of processing video data, performed by an encoder, the method comprising:
obtaining an input sequence comprising a first picture and a second picture;
applying a first retargeting scheme to the first picture to generate a first retargeted picture and a second retargeting scheme to the second picture to generate a second retargeted picture;
encoding the first retargeted picture to generate a first encoded picture;
decoding the first encoded picture to generate a first decoded picture;
adapting the first decoded picture to the second retargeting scheme to generate a reference picture;
encoding the second retargeted picture to generate a second encoded picture, wherein encoding the second retargeted picture comprises inter prediction using the reference picture; and
generating a bitstream comprising the first and second encoded pictures.

14. The method of claim 13, further comprising analysing the first and second pictures to identify one or more regions of interest in each of the first and second pictures, determining the first retargeting scheme in dependence on one or more regions of interest in the first picture and the second retargeting scheme in dependence on one or more regions of interest in the second picture.

15. The method of claim 13, further comprising incorporating metadata defining the first and second retargeting schemes into the bitstream.

16. The method of claim 13, further comprising storing the first decoded picture in a picture buffer;
wherein adapting the first decoded picture to the second retargeting scheme to generate the reference picture is performed after storing the first decoded picture in the picture buffer.

17. The method of claim 13, wherein the input sequence further comprises a third picture and the method further comprises:
applying a third retargeting scheme to the third picture to generate a third retargeted picture;
encoding the third retargeted picture to generate a third encoded picture, wherein encoding the third retargeted picture comprises inter prediction using a further reference picture;
wherein the method further comprises:
decoding the second encoded picture to generate a second decoded picture; and
adapting the second decoded picture to the third retargeting scheme to generate the further reference picture.

18. The method according to claim 13, wherein adapting the first decoded picture to the second retargeting scheme comprises region-scaling.

19. The method according to claim 18, wherein region-scaling comprises rectangular region-scaling.

20. The method according to claim 13, wherein adapting the first decoded picture to the second retargeting scheme comprises:
inverse retargeting of the first decoded picture according to the first retargeting scheme; and, subsequently,
forward retargeting of the first decoded picture according to the second retargeting scheme.
